(19) United States
(12) Patent Application Publication
(10) Pub. No.: US 2005/0282103 A1
(43) Pub. Date: Dec. 22, 2005

(54) Air injector having dental mirror mount

(76) Inventors: William K. Kwong, Orinda, CA (US); Matthew Kwong, Orinda, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/985,659

(22) Filed: Nov. 9, 2004

Related U.S. Application Data
(60) Provisional application No. 60/524,132, filed on Nov. 20, 2003.

(51) Int. Cl. A61C 3/00

(52) U.S. Cl. 433/31

(57) ABSTRACT

An air ejector and a dental mirror combination provide optimum view of human dentition during dental surgery. The air ejector includes a base having an air inlet, an air ejector for receiving air from the air inlet on the base and confining air flow to an air discharge for directing impingement of discharged air upon a mirror surface remote from the base. The air ejector further includes a mirror mounting body attached to the base at one end and extending around the air ejector from the base toward the air discharge. Grasping of the mirror mounting body with the hand enables simultaneous manipulation the air ejector and dental mirror to provide optimum view of the human dentition and simultaneous digital manipulation of the handle between the spaced apart protrusions enables positioning of the mirror relative to the air discharge from the same hand.

### CROSS-REFERENCES TO RELATED APPLICATIONS

This invention claims priority from U.S. Provisional Patent Application Ser. No. 60/524,132 filed Nov. 20, 2003 entitled “Air Injector Having Dental Mirror Mount,” filed by the named inventors herein.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

This invention relates to dentistry. More particularly, an air injector having a dental mirror mount is disclosed which mounts the dental mirror in the air stream from the injector and permits mirror manipulation and holding the mirror with one hand.

### BACKGROUND OF THE INVENTION

Dental mirrors have been combined with optical fibers, lamps, water jets, air jets and the like for many years. Most combinations are complex and do not permit individual manipulation of the dental mirror with respect to the optical fibers, lamps, water jets, air jets or other conduits. Exemplary of such combinations are Keller U.S. Pat. No. 3,638,013; Edelman U.S. Pat. No. 3,614,415; Friedman U.S. Pat. No. 3,352,305; White U.S. Pat. No. 3,250,005; Barr U.S. Pat. No. 1,989,162; Beam U.S. Pat. No. 2,176,620; Pilgrim U.S. Pat. No. 4,090,506; and Detsch U.S. Pat. No. 4,629,425.

Exemplary of these disclosures is Friedman U.S. Pat. No. 2,720,702 where a light, air injector, water injector, and an angled mirror are all held in parallel telescoping relationship one to another. While some utility is realized from such multiple mountings, the dental mirror is rendered inaccessible relative to the other components of the complex dental instrument.

In modern dentistry, the dentist typically works with an assistant. As usually positioned, the assistant is on one side of the patient and the dentist is on the opposite side of the patient, with both the dentist and his assistant being positioned adjacent the patient's mount. During dental surgery, as when drilling is performed, one hand of the dentist operates the surgical drill; the other hand of the dentist positions and angles the mirror for optimum view of the typically remote site on the human dentition where the dental surgery is occurring. Inevitably, the mirror occludes because fluid from the surgical drilling is splattered on to the mirror surface. The fluids have their source either in ambient fluids within the patient's mouth or alternatively water and air supplies provided to the drill.

To alleviate this situation, the dentist typically relies on his assistant. As the dentist positions the mirror, the assistant maintains a jet, usually of air, on the mirror to keep the mirror clear from fluid occlusion.

I find this practice less than optimum. Requiring a dental assistant to follow mirror movement within the patient's mouth is needlessly distracting. The dental assistant can be used for far more useful tasks. For example, presuming that the assistant is required to participate in instrument retrieval and exchange from the operating instrument inventory, avoiding a requirement of following mirror movement within the patient's mount enables such retrieval and exchange to occur rapidly and efficiently. Further, dental assistants are frequently utilized in mixing and/or passing cotton wadding, tooth filling materials, and the like. Having the dental assistant's attention diverted to following the mirror within the patient's mouth detracts seriously from these other tasks.

In what follows I disclose a simple mirror mount that enables single-handed mirror manipulation and jet cleaning during dental surgery.

### BRIEF SUMMARY OF THE INVENTION

An air ejector and a dental mirror combination provide optimum view of human dentition during dental surgery. The air ejector includes a base having an air inlet, an air ejector for receiving air from the air inlet on the base and confining air flow to an air discharge for directing impingement of discharged air upon a mirror surface remote from the base. The air ejector further includes a mirror mounting body attached to the base at one end and extending around the air ejector from the base toward the air discharge. The mirror mounting body also defines a plurality of aligned spaced apart protrusions offset from the air ejector. The aligned spaced apart protrusions have aligned bores passing through the aligned spaced apart protrusions for receiving the handle of a dental mirror and aligning the handle generally parallel to the air ejector with portions of the mirror handle being exposed between the spaced apart protrusions. The air ejector is used in combination with a dental mirror. The dental mirror includes a linear handle for grasping by the hand at one end and extends away from the hand at an opposite end. An angled mirror is supported from the linear handle at the opposite end for providing a view of human dentition during dental surgery. The dental mirror handle is placed within the aligned bores at the aligned spaced apart protrusions for disposing the mirror at the air discharge of the air ejector. The mirror mounting body between the aligned spaced apart protrusions defines spatial intervals along the length of the mirror handle to permit relative mirror manipulation with respect to the air discharge. Grasping of the mirror mounting body with the hand enables simultaneous manipulation the air ejector and dental mirror to provide optimum view of the human dentition and simultaneous digital manipulation of the handle between the spaced apart protrusions enables positioning of the mirror relative to the air discharge from the same hand.

### BRIEF DESCRIPTION OF THE DRAWINGS

FIG. 1 is a perspective view of the air ejector of this invention illustrating the base, the air ejector, the mirror mounting body surrounding the air ejector, and the spaced apart protrusions for supporting the handle of the dental mirror;

FIG. 2 is a side elevation view of the apparatus of FIG. 1 illustrating the placement of a dental mirror at the handle within the air ejector; and,

FIG. 3 illustrates the apparatus of FIG. 2 being grasped at a hand for view alignment the mirror while digits from the same hand manipulate their relative to the air ejector for maintaining the mirror reflecting surface free from occlusion.

### DETAILED DESCRIPTION OF THE INVENTION

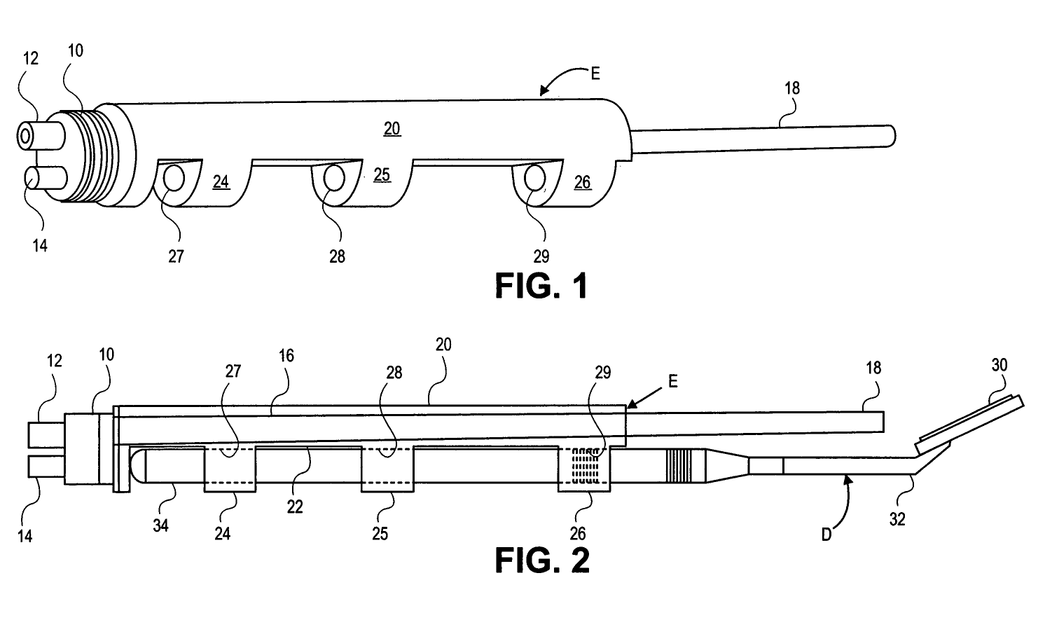

Referring to FIGS. 1 and 2, air ejector E includes base 10 with air inlet 12 and alignment cylinder 14. Connection of the base 10 occurs to standard dental connections which will not be further set forth herein. Ejector conduit 16 extends from base 10 to air discharge 18. Air conventionally funneled through ejector conduit 16 discharges at air discharge 18 to free dental mirrors of occlusion. Ejector conduit 16 is surrounded by a rounded mirror mounting body 20. Mirror mounting body 20 generally defines a flat portion 22 and a series of protrusions 24, 25, 26, which protrusions are spaced apart and extend above flat portion 22 of the air ejector E.

Each of the protrusions 24, 25, 26 has respective aligned bores 27, 28, 29. These respective aligned bores are sized to provide a standard dental mirror with a snug fit.

Referring to FIG. 2, dental mirror D is illustrated in side elevation. Inclined reflecting surface 30 is held at an angle with respect to distal mirror 32. Handle portion 34 extends respectively through protrusions 24, 25, 26. As is common in this type of mirror, handle portion 34 is knurled for high friction contact between a holding hand and the mirror.

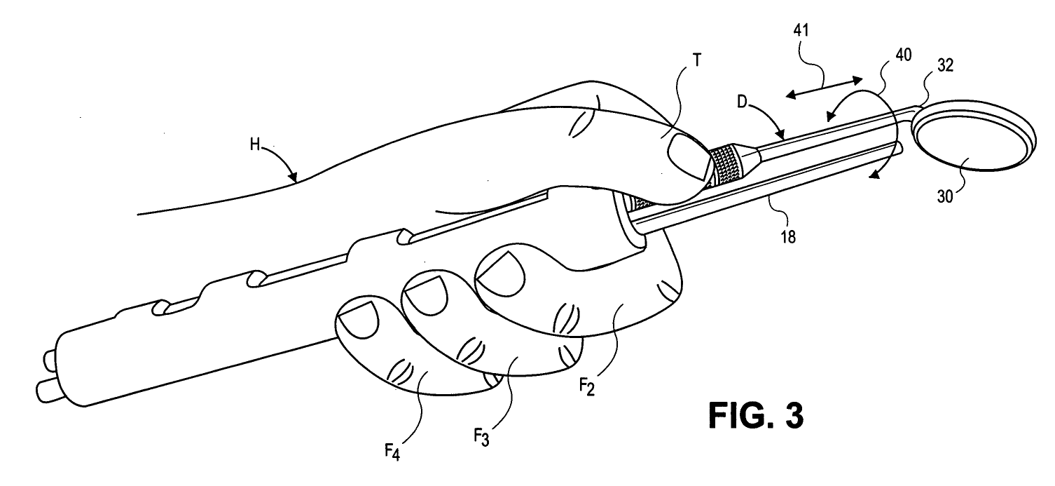

Referring to FIG. 3, dental mirror D is shown placed within ejector E. Specifically, handle 34 is threaded through aligned bores 27, 28, 29 in respective protrusions 24, 25, 26. Thereafter, hand H grasps air ejector E at mounting body 20. Specifically, such grasping occurs between the palm of hand H and the respective fingers F2, F3, and F4. This leaves forefinger F1 and thumb T free to manipulate relative to air ejector E.

As shown in FIG. 3, forefinger F1 and thumb T are free to move handle 34 of dental mirror D relative to air ejector E. Such movement can include rotating dental mirror D in the direction of arrow 40 or alternatively telescoping handle 34 towards an away from base 10 of air ejector E in the direction of arrow 41. Presuming that the dentist utilizing this invention is right-handed, it will be understood that the dentist is operating in precisely guiding a dental surgery drill in his right hand. At the same time, he can position both the mirror and the air ejector with his left-hand so that the combination mirror and air ejector provides the dentist with the best possible view of the surgical drilling. Finally, and presuming that the mirror needs adjustment with respect to the air ejector, utilizing the same left-hand as here shown for the support of the mirror, the dentist can a relatively move the mirror relative to the nozzle of the air ejector with his thumb and forefinger.

1. An air ejector and a dental mirror combination for providing view of human dentition during dental surgery comprising:
an air ejector including:
a base having an air inlet;
an air ejector for receiving air from the air inlet on the base and confining air flow to an air discharge for directing impingement of discharged air upon a mirror surface remote from the base;
a mirror mounting body attached to the base at one end and extending around the air ejector from the base toward the air discharge, the mirror mounting body defining at least one aligned spaced apart bore offset from the air ejector;
a dental mirror in including:
a linear handle for grasping by the hand at one end and extending away from the hand at an opposite end;
an angled mirror supported from the linear handle at the opposite end for providing a view of human dentition during dental surgery;
the mirror mounting body at the at least one bore defining spatial intervals along the length of the mirror handle to permit relative mirror manipulation with respect to the air discharge whereby grasping of the mirror mounting body with the hand enables simultaneous manipulation the air ejector and dental mirror to provide optimum view of the human dentition and simultaneous digital manipulation of the handle between the spaced apart protrusions enables positioning of the mirror relative to the air discharge from the same hand.

2. The air ejector and a dental mirror combination for providing view of human dentition during dental surgery according to claim 1 comprising:
the mirror mounting body including aligned bores passing through the aligned spaced apart protrusions for receiving the handle of a dental mirror and aligning the handle generally parallel to the air ejector with portions of the mirror handle being exposed between the spaced apart protrusions.

3. An air ejector for use in combination with a dental mirror for providing view of human dentition during dental surgery, the dental mirror including,
a linear handle for grasping by the hand at one end and extending away from the hand at an opposite end;
an angled mirror supported from the linear handle at the opposite end for providing a view of human dentition during dental surgery;
the air ejector comprising:
a base having an air inlet;
an air ejector for receiving air from the air inlet on the base and confining air flow to an air discharge for directing impingement of discharged air upon a mirror surface remote from the base;
a mirror mounting body attached to the base at one end and extending around the air ejector from the base toward the air discharge, the mirror mounting body defining at least one bore offset from the air ejector for receiving the linear handle of the dental mirror with portions of the mirror handle being exposed for manipulation by the fingers;
whereby the dental mirror can be manipulated with respect to the air ejector by the digits of a person holding the air ejector and mirror.

4. The air ejector for use in combination with a dental mirror for providing view of human dentition during dental surgery according to claim 3 and further including:
the air ejector further includes aligned bores passing through the aligned spaced apart protrusions for receiving the handle of a dental mirror and aligning the handle generally parallel to the air ejector with portions of the mirror handle being exposed between the spaced apart protrusions.
